(19) United States
(12) Patent Application Publication
(10) Pub. No.: US 2026/0003068 A1
(43) Pub. Date: Jan. 1, 2026

(54) PROCESS FOR DETERMINING A MAP OF AN ENVIRONMENT

(71) Applicant: Logistics and Supply Chain MultiTech R&D Centre Limited, Pok Fu Lam (HK)

(72) Inventors: Ka Lun Fan, Pok Fu Lam (HK); Chi Wai Yiu, Pok Fu Lam (HK); Ziyi Wang, Pok Fu Lam (HK); Chi Fai Kwok, Pok Fu Lam (HK)

(21) Appl. No.: 18/756,403

(22) Filed: Jun. 27, 2024

(51) Int. Cl. G01S 13/89; G01S 17/89; G05D 1/246; G06N 3/094

(52) U.S. Cl. CPC G01S 13/89; G01S 17/89; G05D 1/246; G06N 3/094

(57) ABSTRACT

A process for determining a map of an environment includes receiving millimeter-wave map data associated with an environment, wherein the map data is captured by a millimeter-wave radar; processing the millimeter-wave map data with a machine learning network model trained with a LiDAR data and millimeter-wave radar data; and generating a map of the environment based on the processing of the machine learning network model.

### TECHNICAL FIELD

The invention relates to a process for determining a map of an environment, although not exclusively, to a process for determining a map of a multi-glass environment based on millimeter-wave map data.

### BACKGROUND

With the development of automation technology, mobile robots are widely used in many public places such as shopping malls, restaurants, and transportation hubs. Among them, the construction of environment maps is particularly important, because the maps provide the basis for the robot's path planning and obstacle avoidance. Compared with 3D point cloud maps, 2D grid maps are more commonly used in field of mobile robotics, especially field of indoor robotics, due to the advantages of easy storage and convenient metrics etc.

2D grid map is formed by obstacle areas, unobstructed areas and unknown areas, with the final quality of the map greatly depends on the sensors used for environment sensing. Currently, there are two types of mainstream sensors, namely LiDAR and optical cameras. However, these sensors may not perform well in specific environments. For example, LiDAR may not be able to detect targets with high transparency and does not work in foggy and smoky environments, while optical cameras are unstable in darker or brighter environments. As glass and mirrors are the main building materials used nowadays and they can be found everywhere e.g., in shopping malls and transportation hubs, constructing maps with these mainstream sensors will fail to live up to expectations.

### SUMMARY OF THE INVENTION

In accordance with a first aspect of the present invention, there is provided a process for determining a map of an environment, comprising:
receiving millimeter-wave map data associated with an environment, wherein the map data is captured by a millimeter-wave radar;
processing the millimeter-wave map data with a machine learning network model trained with a LIDAR data and millimeter-wave radar data; and
generating a map of the environment based on the processing of the machine learning network model.

In accordance with the first aspect, the training of the machine learning network model further comprises the step of correlating the LiDAR data and millimeter-wave radar data each corresponding to the same position on the map of the environment. In accordance with the first aspect, the training of the machine learning network model further comprises the step of obtaining millimeter-wave radar data containing a relative position within a training environment and signal-to-noise ratio associated with the relative position.

In accordance with the first aspect, the training of the machine learning network model further comprises the step of filtering data with a signal-to-noise ratio exceeding a predetermined threshold.

In accordance with the first aspect, the training of the machine learning network model further comprises the steps of:
generating a millimeter-wave 2D grid map (x) based on odometry data and millimeter-wave map data;
generating a LiDAR 2D grid map (y) based on odometry data and LiDAR map data; and
comparing the millimeter-wave 2D grid map (x) against the LiDAR 2D grid map (y).

In accordance with the first aspect, the training of the machine learning network model further comprises the steps of data enhancement of the 2D millimeter-wave grid map (x) and LiDAR 2D grid map (y):
if the size of millimeter-wave 2D grid map (x) and LiDAR 2D grid map (y) exceeds a predetermined threshold, the grid maps are extracted by a square cropper and the identical areas of the millimeter-wave 2D grid map (x) and LiDAR 2D grid map (y) are captured; and
if the size of millimeter-wave 2D grid map (x) and LiDAR 2D grid map (y) are below a predetermined threshold, the grid maps are uniformly cropped and adjusted to a predetermined size by interpolation.

In accordance with the first aspect, the machine learning network model comprises a generative adversarial network (GAN) comprising:
a generator (G) configured to generate estimated map info associated with a training environment; and
a discriminator (D) configured to determine the accuracy of the estimated map info generated by the generator (G).

In accordance with the first aspect, the generator (G) is configured to generate a fake 2D grid map (y′) based on millimeter-wave map data associated with the training environment.

In accordance with the first aspect, the generator (G) comprises a plurality of down-sampled convolutional layers with residual modules, a plurality of up-sampled transposed convolutional layers, and a bottom residual module.

In accordance with the first aspect, the discriminator (D) is configured to differentiate:
first map data comprising the fake 2D grid map (y′) generated by the generator (G) based on millimeter-wave map data associated with the training environment and a millimeter-wave radar 2D grid map (x) generated based on millimeter-wave map data associated with the training environment; and
second map data comprising a LiDAR 2D grid map (y) generated based on LiDAR map data associated with the training environment and a millimeter-wave radar 2D grid map (x) generated based on millimeter-wave map data associated with the training environment.

In accordance with the first aspect, the discriminator (D) is a multi-scale discriminator and comprises a first discriminator (D1) and a second discriminator (D2), the first and second map data being transmitted to the first discriminator (D1) and the same first and second map data upon down sampling also being transmitted to the second discriminator (D2).

In accordance with the first aspect, the discriminator (D) comprises an input layer, an output layer, and a plurality of continuously deepening convolutional layers.

In accordance with the first aspect, the machine learning network model further comprises a VGG19 pre-trained CNN model configured to differentiate the feature matching between:
a fake 2D grid map (y′) generated by the generator (G) based on millimeter-wave map data associated with the training environment; and
a LIDAR 2D grid map (y) generated based on LiDAR map data associated with the training environment.

In accordance with the first aspect, the machine learning network model is configured to minimize a combined loss function comprising:
a loss function L_{GAN} for the generative adversarial network (GAN); and
a loss function L_{FM} for the feature matching between a fake 2D grid map (y′) generated by the generator (G) based on millimeter-wave map data associated with the training environment and a LIDAR 2D grid map (y) generated based on LiDAR map data associated with the training environment.

In accordance with the first aspect, the loss function L_{GAN} for the generative adversarial network (GAN) is determined based on the discriminator error of the discriminator (D) associated with the combination of:
first map data comprising the fake 2D grid map (y′) and a millimeter-wave radar 2D grid map (x) generated based on millimeter-wave map data associated with the training environment; and
second map data comprising a LiDAR 2D grid map (y) generated based on LiDAR map data and the millimeter-wave radar 2D grid map (x).

In accordance with the first aspect, the loss function L_{FM} for the feature matching is determined based on the combination of:
an output from the VGG19 pre-trained CNN model representing the feature matching error of the fake 2D grid map (y′) and the LiDAR 2D grid map (y); and
an output from the discriminator (D) representing the feature matching error associated with the first and second map data.

In accordance with the first aspect, the loss function L_{GAN} is defined by:

$$\begin{matrix}{L}_{GAN} ( G , D ) = {E}_{( x , y )} [ log ( D ( x , y ) ] + {E}_{( x , {y}^{′} )} [ log ( D ( x , {y}^{″} ) ] \\ = {E}_{( x , y )} [ log ( D ( x , y ) ] + {E}_{( x )} [ log ( D ( G ( x ) ) ]\end{matrix}$$

In accordance with the first aspect, the loss function L_{FM} is defined by:

$$\begin{matrix}{L}_{FM} ( G , {D}_{k} , Vgg ) = \begin{matrix}{λ}_{D} {\sum }_{k = 1 , 2} {E}_{( y ′ , y )} {\sum }_{i = 1}^{3} \frac{1}{{N}_{i}} [ {‖ {D}_{k}^{( i )} ( x , y ) - {D}_{k}^{( i )} ( x , {y}^{′} ) ‖}_{1} ] + \\ {λ}_{Vgg} {E}_{( y ′ , y )} {\sum }_{i = 1}^{5} \frac{1}{{N}_{i}} [ {‖ {Vgg}^{( i )} ( y ) - {Vgg}^{( i )} ( {y}^{′} ) ‖}_{1} ]\end{matrix} \\ = \begin{matrix}{λ}_{D} {\sum }_{k = 1 , 2} {E}_{( x , y )} {\sum }_{i = 1}^{3} \frac{1}{{N}_{i}} [ {‖ {D}_{k}^{( i )} ( x , y ) - {D}_{k}^{( i )} ( x , G ( x ) ) ‖}_{1} ] + \\ {λ}_{Vgg} {E}_{( x , y )} {\sum }_{i = 1}^{5} \frac{1}{{N}_{i}} [ {‖ {Vgg}^{( i )} ( y ) - {Vgg}^{( i )} ( G ( x ) ) ‖}_{1} ]\end{matrix}\end{matrix}$$

where

$${D}_{k}^{( i )}$$

( ) is the k^{th} discriminator's output in the i^{th} layer;
Nᵢ is the size of the output elements of the discriminators or the total size of the output elements in layer i of the VGG19 model; λ_{D} is the weight of the feature matching loss function of discriminator; and
λᵥ_{_{gg}} is the weight of the feature matching loss function of VGG19 model

In accordance with the first aspect, the model training strategy for the generative adversarial network (GAN) is defined by:

$${min}_{G} ( {max}_{( D 1 , D 2 )} ( {\sum }_{k = 1 , 2} {L}_{GAN} ( G , {D}_{k} ) ) + {L}_{FM} ( G , {D}_{k} , Vgg ) )$$

In accordance with the first aspect, further comprising the step of deriving a navigational path of a robot based on the map of the environment generated by the machine learning network model.

### BRIEF DESCRIPTION OF THE DRAWINGS

Embodiments of the present invention will now be described, by way of example, with reference to the accompanying drawings in which:

FIG. 1 shows a millimeter-wave radar map around a concrete wall with a plurality of single-frame data sparsely distributed;

FIG. 2 is a flow diagram showing the operation workflow of the process for determining a map of an environment in accordance with an embodiment of the present invention;

FIG. 3 is a flow diagram showing the operation workflow of the machine learning network model of the process of FIG. 2;

FIG. 4 is a schematic diagram showing one configuration of the machine learning network model of FIG. 3;

FIG. 5 depicts a real-world multi-glass environment for 2D grid map construction by millimeter-wave and LiDAR; and

FIG. 6A depicts a LIDAR 2D grid map of the multi-glass environment of FIG. 5 constructed by conventional LiDAR only;

FIG. 6B depicts a millimeter-wave radar 2D grid map of the multi-glass environment of FIG. 5 constructed directly by conventional millimeter-wave; and

FIG. 6C depicts a millimeter-wave radar 2D grid map of the multi-glass environment of FIG. 5 constructed by processing millimeter-wave by the trained machine learning network model in accordance with one example embodiment of the present invention.

### DETAILED DESCRIPTION OF THE PREFERRED EMBODIMENTS

LiDAR is a radar system that emits laser beams to detect characteristic quantities such as the position and speed of targets. Millimeter-wave (mmWave) radar refers to the radar that works in the millimeter wave band. Millimeter waves are essentially electromagnetic waves.

Millimeter-wave radar is different from LiDAR and vision cameras. In terms of physical principle, the frequency band of millimeter wave is distributed in 30 GHZ-300 GHZ, and the wavelength has 1-10 mm, which is much longer than that of laser and visible light. Thus, LiDAR is less likely to penetrate through transparent materials such as glass. For the reason of such characteristic of millimeter wave, millimeter-wave radar is more suitable for constructing maps for the glass-intensive environments.

The construction of 2D grid maps is a classical task in the field of mobile robotics, and there are already some rather mature and proven effective methods, for example laser SLAM algorithms mainly based on LIDAR such as Gmapping, Cartographer, Hector, LOAM, etc., and vision SLAM algorithms mainly based on optical cameras such as ORB-SLAM. These algorithms are based on the basic process from sensor data to front-end, back-end, loopback detection, and final map building. This is generally performed by subscribing to sensor and odometer data so as to complete tasks such as data association, feature point matching, localization, and global optimization. Since these methods are still inevitably affected by the errors caused by update frequency, environment, and other factors in practical problems, solutions using deep learning to complete some or all of the basic SLAM processes have also arisen in recent years.

The reliability and accuracy of millimeter-wave radar has significant shortcomings compared to mainstream radar. This is due to the fact that the data detected in a single frame of millimeter-wave radar tends to be very sparse and has a poor accuracy. In addition, as millimeter-wave radar is a radio-frequency (RF) technology, it is susceptible to multiple path transmissions within an indoor working environment. The data would also contain a large amount of noise especially when the radar is moving.

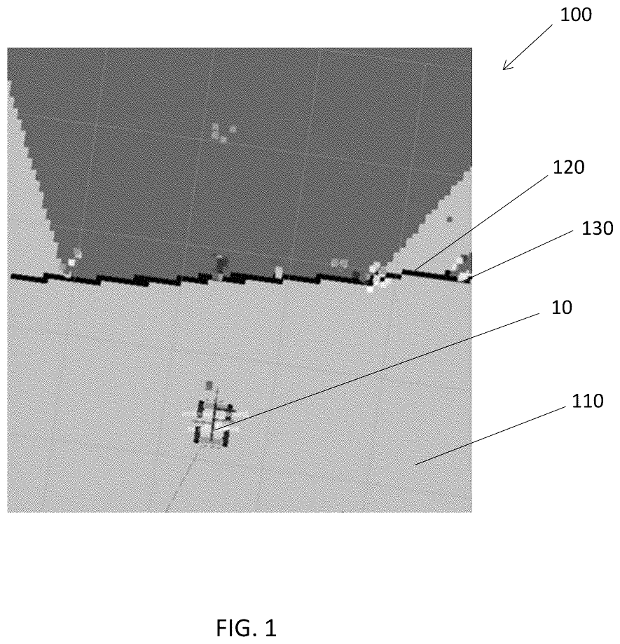

As shown in FIG. 1, there is shown the millimeter-wave radar 2D grid map 100 which includes a plurality of grids 110 each representing a portion of the 2D indoor environment to be navigated by a navigational robot 10 with a millimeter-wave radar. The indoor environment is divided into obstacle areas, unobstructed areas and unknown areas. The obstacle area may be a concrete wall 120 which obstructs the navigation of the robot 10.

The grid representing the portion of the area 130 proximate to the concrete wall 120 e.g., grid in front of the concrete wall 120 are graphically represented by single-frame data (colored point cloud) of the millimeter-wave radar. As these point clouds are very spare, it may not reflect the length and width of the concrete wall 120. The noise also exists in those point clouds representing the grid ahead the radar on the navigational robot 10 and those point clouds representing the grid behind the concrete wall 120 where there are no obstacles.

Commonly used point cloud data post-processing methods include feature extraction, segmentation, clustering and other algorithms. However, the accuracy of millimeter-wave radar data processed only by the above methods is still below satisfactory. This is because the single-frame point cloud data of millimeter-wave radar is too small for direct post-processing, and the multi-frame point cloud data on the map may lead to target stacking which may not be able to reflect the location, shape and size of the obstacles accurately.

In addition, while it is also possible to construct the map with the aforementioned classic SLAM algorithms using laser data from millimeter-wave radar, these algorithms often have strict requirements on sensor quality e.g., generally require radars with high update frequency and low level of noise. Also, once the size of the environment increases, the memory and computation required for map construction will also increase rapidly. Therefore, if millimeter-wave radar is to be used to construct grid maps, it is necessary to redesign effective data processing and map construction schemes.

Without wishing to be bound by theories, the inventors of the present invention have devised a deep learning-based millimeter-wave radar 2D grid map construction method to address at least one or more of the abovementioned shortcomings and drawbacks of the prior art.

Advantageously, the deep learning model may compare or process the map data obtained by millimeter wave radar against other sources e.g., LiDAR and calibrate the errors found in the millimeter wave radar map. Accordingly, the present invention may take advantage of the unique characteristics of millimeter waves and LiDAR, by combining the two sources to devise a map generation source that can be used to construct high quality maps by using only millimeter wave radar. Furthermore, this map generation source or generator may be particularly advantageous for use in environments where there are transparent obstacles such as multi-glass indoor environment which may pose accuracy challenges to other forms of mapping methods.

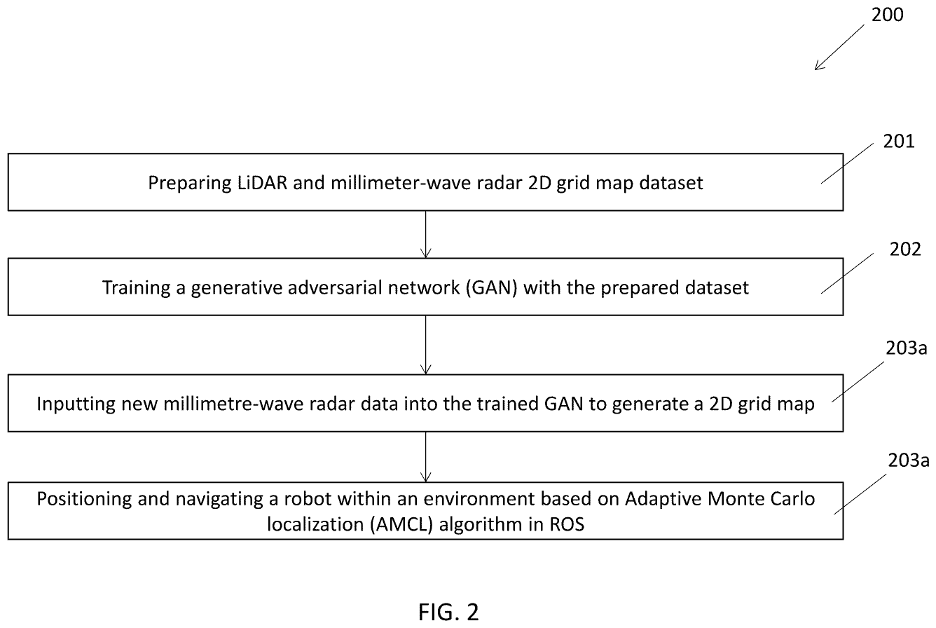

With reference now to FIG. 2, there is shown an embodiment of a process for determining a map of an environment, comprising: receiving millimeter-wave map data associated with an environment, wherein the map data is captured by a millimeter-wave radar; processing the millimeter-wave map data with a machine learning network model trained with a LiDAR data and millimeter-wave radar data; and generating a map of the environment based on the processing of the machine learning network model.

As shown in FIG. 2, the method includes three essential steps: preparing LiDAR and millimeter-wave radar 2D grid map dataset (step 201), training a generative adversarial network (GAN) with the prepared LiDAR and millimeter-wave radar 2D grid map dataset (step 202), inputting new millimeter-wave radar data into the trained generative adversarial network (GAN) by step 202 to generate a 2D grid map (step 203a) and positioning and navigating a robot 10 within an environment based on Adaptive Monte Carlo localization (AMCL) algorithm in ROS (step 203b).

The preparation of LiDAR and millimeter-wave radar 2D grid map dataset in step 201 will now be explained, which includes the following step:
Step 1. Obtain a single frame data acquired by millimeter-wave radar. The data includes: Cartesian position coordinates of the target relative to the radar and the signal-to-noise ratio of the target signal. Using a passthrough filter to perform filtering on four channels of the coordinates and the signal-to-noise ratio.
Step 2: Subscribe to the odometer and the filtered millimeter wave radar topic in the Robot Operating System (ROS), and obtain multi-frame point cloud data and the position data collected within the millimeter wave radar movement in a glass-free normal environment, and then store the target point cloud in an octree map.
Step 3: Use a statistical filter to remove outliers from the point cloud data in the octree map, and then project the three-dimensional point cloud to a two-dimensional plane (x-y ground plane) to obtain a two-dimensional grid map of the millimeter wave radar.
Step 4: Set the same initial position for the LiDAR and millimeter-wave radar, subscribe to the LiDAR and odometer topics in ROS, and construct a 2D grid map of the LiDAR in the same real-world environment as that of the millimeter-wave radar by using the GMapping algorithm.
Step 5: Align a set of 2D grid maps of millimeter-wave radar and LiDAR to the same origin using affine transformation. The affine transformation can be represented by a 2×3 matrix MA:

$${M}_{A} = [ A B ] = {[ \begin{matrix}{a}_{00} & {a}_{01} & {b}_{00} \\ {a}_{10} & {a}_{11} & {b}_{10}\end{matrix} ]}_{2 \times 3}$$

Since the LiDAR and the millimeter wave radar are set to the same initial position and the original map is not scaled, the linear transformation matrix A is a unit matrix of order 2, i.e., a₀₀=a₁₁=1, a₀₁=a₁₀=0. When the grid maps are stored in the ROS, the positional coordinates of the map origin and the map accuracy are also recorded simultaneously, and thus it is easy to obtain the pixel position of the map origin in the image. Thus, the values of b₀₀ and b₁₀ can be calculated by equating to the difference between the pixel positions of the origin of the two grid maps in the horizontal and vertical directions, respectively.
Step 6: Adjust the aligned set of millimeter wave radar and lidar 2D grid maps to the same size. Since the unknown regions of the grid maps have fixed pixel values, the boundaries can be directly complemented with constant padding for the smaller maps.
Step 7: Perform data enhancement on two maps of the same set, the specific strategy would be: If the set of maps is large enough, a fixed-size square cropper would be used to directly extract the same region. If the set of maps is smaller, it would be directly and uniformly cropped and then adjusted to the target size by the nearest-neighbor interpolation method; Rotate and flip the set of cropped images to obtain multiple sets of map images, and repeat aforementioned random cropping, rotating and flipping of the same sets of map images multiple times. Through this strategy, a large number of grid maps with different scales of resolution can be obtained, and here, the preparation for a plurality of sets of millimeter wave radar and LiDAR 2D grid data corresponding to the same real-world environment is completed.
Step 8: Repeat the above steps 1-7 in multiple real-world environments to complete the dataset collection.

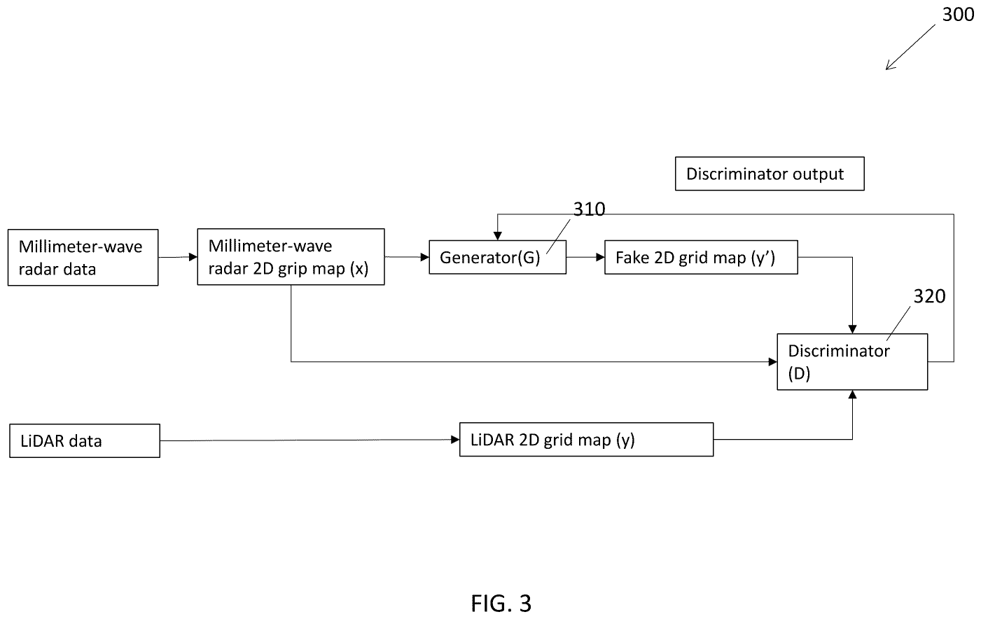

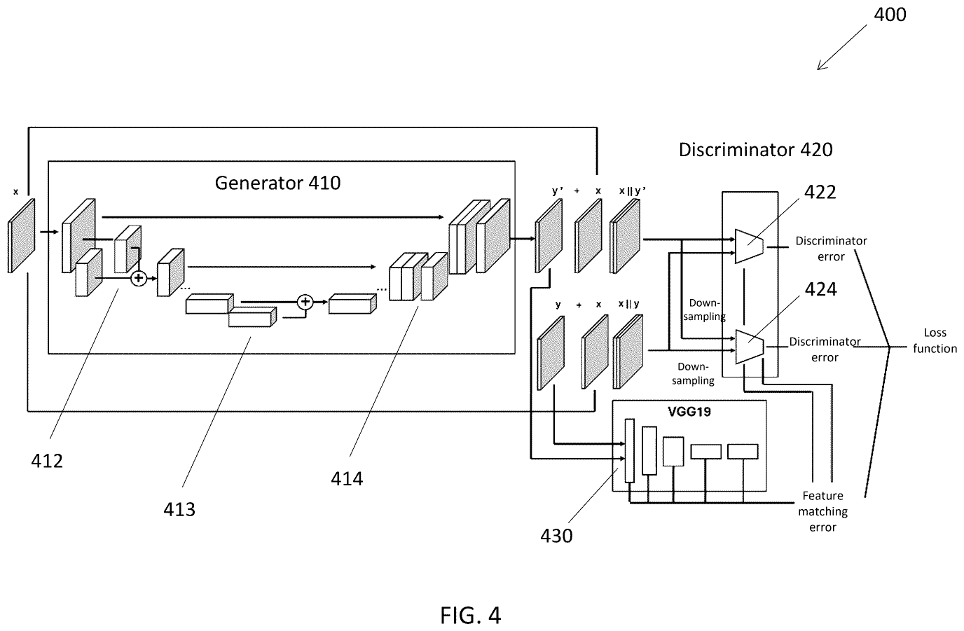

The training of a generative adversarial network (GAN) with the prepared LiDAR and millimeter-wave radar dataset in step 202 will now be explained with reference to FIGS. 3 and 4.

With reference to FIG. 3, there is shown a flow diagram showing the operation workflow of the machine learning network model 300, which is generative adversarial network (GAN) and comprises a generator (G) 310 for generating a map output associated with a training environment and a discriminator (D) 320 for differentiating between the generated map output and a reference point.

Initially, millimeter-wave radar data is being processed to generate a millimeter-wave radar two-dimensional grid map (x). The generator (G) 310 is fed with the millimeter-wave radar two-dimensional grid map (x) and it may generate a fake 2D grip map (y′). In parallel, LiDAR data is also processed to generate a LIDAR 2D grid map (y). The discriminator (D) 320 is then fed with the fake 2D grip map (y′), LiDAR 2D grid map (y) and millimeter-wave radar two-dimensional grid map (x). The discriminator (D) 320 may differentiate between the fake 2D grip map (y′) and LiDAR 2D grid map (y), evaluate the accuracy of the fake 2D grip map (y′) and generate a discriminator output which would be feedback to the generator (G) 310. The generator (G) 310 would regenerate another fake 2D grip map (y′) and this process will be reiterated until the fake 2D grip map (y′) is close enough to the LiDAR 2D grid map (y) i.e., the quality of the fake 2D grip map (y′) determined by the discriminator (D) has reached a predetermined threshold.

In one example embodiment, a specific training model 400 of the generative adversarial network (GAN) is shown in FIG. 4, in which the 3D rectangle represents the size of the input map image in the model, the 2D quadrilateral represents the neural network layer, and the arrows represent the transfer direction of the image data or error. The specific training model 400 may include generator 410 and a multi-scale discriminator 420.

The generator 410 may include an encoder-decoder arrangement having an encoder 412 and a decoder 414. The encoder 412 may receive an input in the form of a millimeter-wave radar map (x) which can be encoded into an encoded input 413. The encoded input 413 may then be decoded by the decoder 414 to generate an output in the form of a fake map (y′).

Preferably, the generator 410 may be similar to the skeleton of UNet and primarily includes four 2×2 down-sampled convolutional layers with residual modules, four 2×2 up-sampled transposed convolutional layers, and a bottom residual module. Except for the bottom residual module, the data outputs of the 4 down-sampled layers through the residual module are summed with the data outputs of the corresponding up-sampled transposed convolutional layers by the method of hopping over the connection respectively, and then the number of channels is compressed to half through the convolutional layers, and finally inputted to the next up-sampled transposed convolutional layer.

The model is fed with the same set of millimeter-wave radar two-dimensional grid map (x) and laser radar two-dimensional grid map (y). The generator 410 accepts the millimeter-wave radar map (x) and generates a fake map (y′), and then the millimeter-wave radar map (x) is fed to the multi-scale discriminator 420 together with the laser radar map (y) and the generated fake map (y′) respectively.

The multi-scale discriminator 420 may generate a first discriminator output D(x, y) which is a mapping of the millimeter-wave radar map (x) and the LiDAR map (y). The multi-scale discriminator 420 may also generate a second discriminator output D(x, y′) which is a mapping of the millimeter-wave radar map (x) and the generated fake map (y′).

Preferably, the multi-scale discriminator 420 may include a pair of two discriminators 422, 424 with the same structure, each of which includes three ever-deepening convolutional layers in addition to the input and output layers, with a final output channel number of one.

Advantageously, a 2×2 down-sampling of the maps is performed before feeding into one of the two discriminators e.g., discriminator 424 so that the multi-scale discriminator 420 is better adapted to map inputs of different resolutions.

In one example embodiment, the specific model 400 may further include pre-trained Very Deep Convolutional Networks (VGG) e.g. a VGG19 model 430 which may be utilized to identify several features of interest and the findings can be output for further data processing. For instance, the generated fake map (y′) and the LiDAR map (y) can be processed by the pre-trained VGG19 model so as to classify the generated fake map (y′) and the LiDAR map (y) into various object categories.

In order to train the aforementioned model, the loss function is designed with reference to Pix2PixHD, and the objective function may include two parameters:
the loss function L_{GAN} for generative adversarial network (GAN), and
the loss function L_{FM} for the feature matching between the LiDAR map (y) and the generated fake map (y′).

Preferably, the loss function L_{GAN} for the generative adversarial network (GAN) may be determined based on the discriminator error of the discriminator 420 associated with the combination of:
mapping of the fake 2D grid map (y′) and the millimeter-wave radar 2D grid map (x); and
mapping of the LiDAR 2D grid map (y) and the millimeter-wave radar 2D grid map (x).

L_{GAN} is defined as follows:

$$\begin{matrix}{L}_{GAN} ( G , D ) = {E}_{( x , y )} [ log ( D ( x , y ) ] + {E}_{( x , {y}^{′} )} [ log ( D ( x , {y}^{″} ) ] \\ = {E}_{( x , y )} [ log ( D ( x , y ) ] + {E}_{( x )} [ log ( D ( G ( x ) ) ]\end{matrix}$$

L_{GAN} can be obtained by setting the label of the generated fake map (y′) as 0, the label of the LiDAR map (y) as 1 and calculating the sum of the mean square error of the outputs of the two discriminators 422, 424.

Preferably, the loss function L_{FM} for the feature matching may be determined based on the combination of:
an output from the VGG19 pre-trained CNN model 430 representing the feature matching error of the fake 2D grid map (y′) and the LiDAR 2D grid map (y); and
an output from the discriminator 430 representing the feature matching error associated with the combination of the mapping of the fake 2D grid map (y′) and the millimeter-wave radar 2D grid map (x) and of the LiDAR 2D grid map (y) and the millimeter-wave radar 2D grid map (x).

L_{FM} is defined as follows:

$$\begin{matrix}{L}_{FM} ( G , {D}_{k} , Vgg ) = \begin{matrix}{λ}_{D} {\sum }_{k = 1 , 2} {E}_{( y ′ , y )} {\sum }_{i = 1}^{3} \frac{1}{{N}_{i}} [ {‖ {D}_{k}^{( i )} ( x , y ) - {D}_{k}^{( i )} ( x , {y}^{′} ) ‖}_{1} ] + \\ {λ}_{Vgg} {E}_{( y ′ , y )} {\sum }_{i = 1}^{5} \frac{1}{{N}_{i}} [ {‖ {Vgg}^{( i )} ( y ) - {Vgg}^{( i )} ( {y}^{′} ) ‖}_{1} ]\end{matrix} \\ = \begin{matrix}{λ}_{D} {\sum }_{k = 1 , 2} {E}_{( x , y )} {\sum }_{i = 1}^{3} \frac{1}{{N}_{i}} [ {‖ {D}_{k}^{( i )} ( x , y ) - {D}_{k}^{( i )} ( x , G ( x ) ) ‖}_{1} ] + \\ {λ}_{Vgg} {E}_{( x , y )} {\sum }_{i = 1}^{5} \frac{1}{{N}_{i}} [ {‖ {Vgg}^{( i )} ( y ) - {Vgg}^{( i )} ( G ( x ) ) ‖}_{1} ]\end{matrix}\end{matrix}$$

L_{FM} can be obtained by calculating:
the L1 paradigm between LiDAR map (y) and fake map (y′) in the middle 3 layers of outputs of the discriminators 422, 424; and
the L1 paradigm between LiDAR map (y) and fake map (y′) in the idle 5 layers of outputs of the pre-trained VGG19 model 430;
where:

$${D}_{k}^{( i )}$$

( ) is the k^{th} discriminator's output in the i^{th} layer;
Nᵢ is the size of the output elements of the discriminators 422, 424 or the total size of the output elements in layer i of the VGG19 model 430;
λ_{D} is the weight of the feature matching loss function computed by the discriminators 422, 424; and
λ_{V}_{_{gg}} is the weight of the feature matching loss function computed by the pre-trained VGG19 model 430

The model training strategy for the generative adversarial network (GAN) is a mini-max problem for minimizing the possible loss for a maximum loss of the combination of the loss function L_{GAN} and the loss function L_{FM}, which can be represented by:

$${min}_{G} ( {max}_{( D 1 , D 2 )} ( {\sum }_{k = 1 , 2} {L}_{GAN} ( G , {D}_{k} ) ) + {L}_{FM} ( G , {D}_{k} , Vgg ) )$$

Lastly, the prepared 2D grid map LiDAR and millimeter-wave radar dataset in step 201 can be input to complete the training of the generative adversarial network (GAN) of the model 400.

The input of the new millimeter-wave radar data into the trained generative adversarial network (GAN) to generate a 2D grid map in step 203a and the positioning and navigating of the robot within an environment based on Adaptive Monte Carlo localization (AMCL) algorithm in ROS in step 203b will now be explained in further details.

The new millimeter-wave radar map data is prepared with the same method as aforementioned and would be input into the trained generative adversarial network (GAN) to generate a two-dimensional grid map (step 203a). However, in contrast with the training step of 202, it is no longer necessary to construct the two-dimensional grid map with LiDAR. A high-quality 2D grid map can be obtained by simply using the millimeter-wave radar through the aforementioned trained model generative adversarial network.

Based on the Adaptive Monte Carlo localization (AMCL) algorithm in ROS, the real-time position of the mobile robot 10 in the map can be subsequently obtained by inputting the 2D grid map generated by the above method and the topic data of millimeter-wave radar projected onto the 2D plane (ground). The navigation of the mobile robot 10 can be accomplished by configurating, running, and interacting with the navigation stack on the robot 10. For instance, this can be achieved by the “move_base” toolkit in the ROS interface.

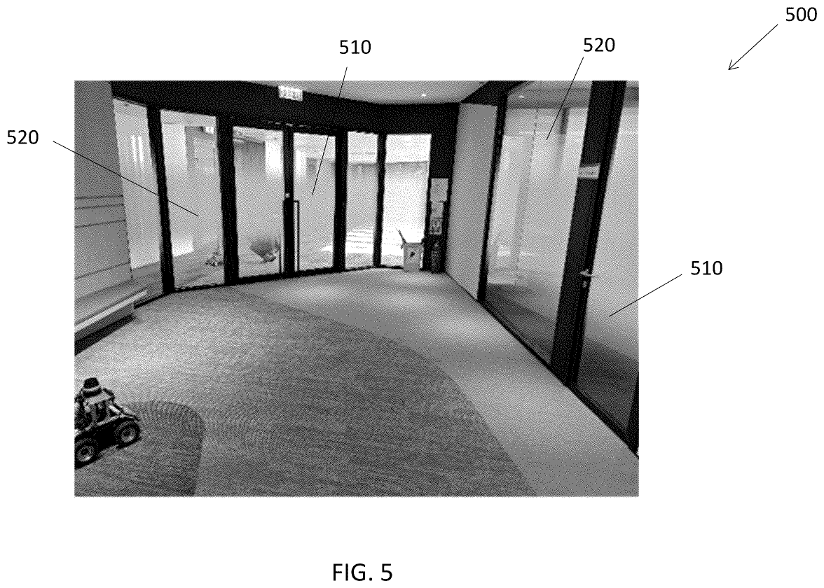

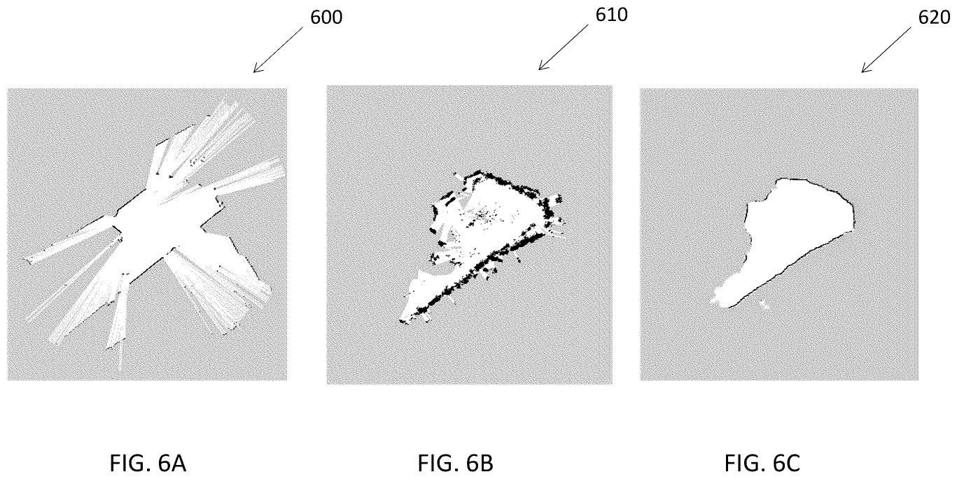

With reference finally to FIGS. 5 to 6C for the detailed description of the quality of the 2D grid map generated for an indoor environment 500 by using conventional radars and the trained machine learning network model in accordance with the present invention. The environment 500 for radar scanning may be an environment full of glass materials such as multiple glass doors 510 and windows 520.

Referring to FIG. 6A, the glass information cannot be captured by the GMapping algorithm using LiDAR directly and thus the LiDAR 2D grid map 600 is incomplete. Referring to FIG. 6B, the map information recorded by millimeter-wave radar directly is of poor quality and the millimeter-wave radar 2D grid map 610 cannot be used at all. In contrast, Referring to FIG. 6C, the 2D grid map 620 generated by millimeter-wave radar using the method as suggested by the present invention can capture glass obstacles while maintaining high accuracy, which combines the advantages of millimeter-wave radar and LiDAR as well as circumventing each of their shortcomings respectively.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A process for determining a map of an environment, comprising:
receiving millimeter-wave map data associated with an environment, wherein the map data is captured by a millimeter-wave radar;
processing the millimeter-wave map data with a machine learning network model trained with a LIDAR data and millimeter-wave radar data; and
generating a map of the environment based on the processing of the machine learning network model.

2. The process in accordance with claim 1, wherein the training of the machine learning network model further comprises the step of correlating the LiDAR data and millimeter-wave radar data each corresponding to the same position on the map of the environment.

3. The process in accordance with claim 2, wherein the training of the machine learning network model further comprises the step of obtaining millimeter-wave radar data containing a relative position within a training environment and signal-to-noise ratio associated with the relative position.

4. The process in accordance with claim 3, wherein the training of the machine learning network model further comprises the step of filtering data with a signal-to-noise ratio exceeding a predetermined threshold.

5. The process in accordance with claim 3, wherein the training of the machine learning network model further comprises the steps of:
generating a millimeter-wave 2D grid map (x) based on odometry data and millimeter-wave map data;
generating a LiDAR 2D grid map (y) based on odometry data and LiDAR map data; and
comparing the millimeter-wave 2D grid map (x) against the LiDAR 2D grid map (y).

6. The process in accordance with claim 5, wherein the training of the machine learning network model further comprises the steps of data enhancement of the 2D millimeter-wave grid map (x) and LiDAR 2D grid map (y):
if the size of millimeter-wave 2D grid map (x) and LiDAR 2D grid map (y) exceeds a predetermined threshold, the grid maps are extracted by a square cropper and the identical areas of the millimeter-wave 2D grid map (x) and LiDAR 2D grid map (y) are captured; and
if the size of millimeter-wave 2D grid map (x) and LiDAR 2D grid map (y) are below a predetermined threshold, the grid maps are uniformly cropped and adjusted to a predetermined size by interpolation.

7. The process in accordance with claim 1, wherein the machine learning network model comprises a generative adversarial network (GAN) comprising:
a generator (G) configured to generate estimated map info associated with a training environment; and
a discriminator (D) configured to determine the accuracy of the estimated map info generated by the generator (G).

8. The process in accordance with claim 7, wherein the generator (G) is configured to generate a fake 2D grid map (y′) based on millimeter-wave map data associated with the training environment.

9. The process in accordance with claim 7, wherein the generator (G) comprises a plurality of down-sampled convolutional layers with residual modules, a plurality of up-sampled transposed convolutional layers, and a bottom residual module.

10. The process in accordance with claim 8, wherein the discriminator (D) is configured to differentiate:
first map data comprising the fake 2D grid map (y′) generated by the generator (G) based on millimeter-wave map data associated with the training environment and a millimeter-wave radar 2D grid map (x) generated based on millimeter-wave map data associated with the training environment; and
second map data comprising a LIDAR 2D grid map (y) generated based on LiDAR map data associated with the training environment and a millimeter-wave radar 2D grid map (x) generated based on millimeter-wave map data associated with the training environment.

11. The process in accordance with claim 10, wherein the discriminator (D) is a multi-scale discriminator and comprises a first discriminator (D1) and a second discriminator (D2), the first and second map data being transmitted to the first discriminator (D1) and the same first and second map data upon down sampling also being transmitted to the second discriminator (D2).

12. The process in accordance with claim 7, wherein the discriminator (D) comprises an input layer, an output layer, and a plurality of continuously deepening convolutional layers.

13. The process in accordance with claim 7, wherein the machine learning network model further comprises a VGG19 pre-trained CNN model configured to differentiate the feature matching between:
a fake 2D grid map (y′) generated by the generator (G) based on millimeter-wave map data associated with the training environment; and
a LIDAR 2D grid map (y) generated based on LiDAR map data associated with the training environment.

14. The process in accordance with claim 7, wherein the machine learning network model is configured to minimize a combined loss function comprising:
a loss function L_{GAN} for the generative adversarial network (GAN); and
a loss function L_{FM} for the feature matching between a fake 2D grid map (y′) generated by the generator (G) based on millimeter-wave map data associated with the training environment and a LIDAR 2D grid map (y) generated based on LiDAR map data associated with the training environment.

15. The process in accordance with claim 14, wherein the loss function L_{GAN} for the generative adversarial network (GAN) is determined based on the discriminator error of the discriminator (D) associated with the combination of:
first map data comprising the fake 2D grid map (y′) and a millimeter-wave radar 2D grid map (x) generated based on millimeter-wave map data associated with the training environment; and
second map data comprising a LIDAR 2D grid map (y) generated based on LiDAR map data and the millimeter-wave radar 2D grid map (x).

16. The process in accordance with claim 15, wherein the loss function L_{FM} for the feature matching is determined based on the combination of:
an output from the VGG19 pre-trained CNN model representing the feature matching error of the fake 2D grid map (y′) and the LiDAR 2D grid map (y); and
an output from the discriminator (D) representing the feature matching error associated with the first and second map data.

17. The process in accordance with claim 16, wherein the loss function L_{GAN} is defined by:
$$\begin{matrix}{L}_{GAN} ( G , D ) = {E}_{( x , y )} [ log ( D ( x , y ) ] + {E}_{( x , {y}^{′} )} [ log ( D ( x , {y}^{″} ) ] \\ = {E}_{( x , y )} [ log ( D ( x , y ) ] + {E}_{( x )} [ log ( D ( G ( x ) ) ] .\end{matrix}$$

18. The process in accordance with claim 17, wherein the loss function L_{FM} is defined by:
$$\begin{matrix}{L}_{FM} ( G , {D}_{k} , Vgg ) = \begin{matrix}{λ}_{D} {\sum }_{k = 1 , 2} {E}_{( y ′ , y )} {\sum }_{i = 1}^{3} \frac{1}{{N}_{i}} [ {‖ {D}_{k}^{( i )} ( x , y ) - {D}_{k}^{( i )} ( x , {y}^{′} ) ‖}_{1} ] + \\ {λ}_{Vgg} {E}_{( y ′ , y )} {\sum }_{i = 1}^{5} \frac{1}{{N}_{i}} [ {‖ {Vgg}^{( i )} ( y ) - {Vgg}^{( i )} ( {y}^{′} ) ‖}_{1} ]\end{matrix} \\ = \begin{matrix}{λ}_{D} {\sum }_{k = 1 , 2} {E}_{( x , y )} {\sum }_{i = 1}^{3} \frac{1}{{N}_{i}} [ {‖ {D}_{k}^{( i )} ( x , y ) - {D}_{k}^{( i )} ( x , G ( x ) ) ‖}_{1} ] + \\ {λ}_{Vgg} {E}_{( x , y )} {\sum }_{i = 1}^{5} \frac{1}{{N}_{i}} [ {‖ {Vgg}^{( i )} ( y ) - {Vgg}^{( i )} ( G ( x ) ) ‖}_{1} ]\end{matrix}\end{matrix}$$
where
$${D}_{k}^{( i )}$$
( ) Is the k^{th} discriminator's output in the i^{th} layer;
Nᵢ is the size of the output elements of the discriminators or the total size of the output elements in layer i of the VGG19 model;
λ_{D} is the weight of the feature matching loss function of discriminator; and
λ_{V}_{_{gg}} is the weight of the feature matching loss function of VGG19 model.

19. The process in accordance with claim 18, wherein the model training strategy for the generative adversarial network (GAN) is defined by:
$${min}_{G} ( {max}_{( D 1 , D 2 )} ( {\sum }_{k = 1 , 2} {L}_{GAN} ( G , {D}_{k} ) ) + {L}_{FM} ( G , {D}_{k} , Vgg ) ) .$$

20. The process in accordance with claim 1, further comprising the step of deriving a navigational path of a robot based on the map of the environment generated by the machine learning network model.
